(19) United States
(12) Patent Application Publication
(10) Pub. No.: US 2001/0010678 A1
(43) Pub. Date: Aug. 2, 2001

(54) SPINDLE MOTOR DEVICE FOR DISC PLAYERS

(76) Inventors: YONG CHE JUNG, KYUNGKI-DO (KR); BYUNG SAM SON, KYUNGKI-DO (KR); KI HYUN KIM, KYUNGKI-DO (KR); CHUNG UNG KIM, SEOUL (KR)

Correspondence Address: SUGHRUE MION ZINN, MACPEAK & SEAS, 2100 PENNSYLVANIA AVENUE NW, WASHINGTON, DC, 20037

(21) Appl. No.: 08/933,076

(22) Filed: Sep. 18, 1997

(30) Foreign Application Priority Data
Sep. 18, 1996 (KR) P96-40717

(51) Int. Cl. G11B 23/00; G11B 25/00

(52) U.S. Cl. 369/266

(57) ABSTRACT

A spindle motor device has an integrated rotor in place of a separated turntable. An optical disc is loaded to the turntable when driving means move a tray which can hold at least one optical disc. A bracket is mounted to a deck and has a fixed coil. A rotating shaft is rotatably held on the bracket by bearing means while rotor with turntable function rotates an optical disk chucked by a chucking device.

### BACKGROUND OF THE INVENTION

1. Field of the Invention

The present invention relates, in general, to a spindle motor device for holding and rotating a disc in a disc player and, more particularly, to a spindle motor device with integrated turntable function instead of a separate turntable.

2. Description of the Prior Art

As well known to those skilled in the art, an optical disc player emits a high concentration light beam such as a laser beam onto an optical disc where digital data is recorded, and receives a reflected beam, thereby reading the recorded data in accordance with the difference to the reflected beam.

FIG. 1 shows a deck for disc players with both a spindle motor device and an optical pick up. As shown in the drawing, a disc turntable 1 is rotatably held on the deck 2, with a spindle motor 3 generating a rotating force for the turntable 1. In order to load an optical disc onto the turntable 1, the disc is primarily seated on a disc tray (not shown) and is fed onto the turntable 1 by a tray drive means (not shown). The optical pickup 5 is provided on the deck 2 at an appropriate position spaced apart from the turntable 1 and is movable in a radial direction in relation to the optical disc loaded on the turntable 1. The pickup 5 has an object lens 4 at a predetermined position.

In order to move the pickup 5 relative to the disc, a pickup drive motor 6 is mounted to the deck 2 with a plurality of transmission gears 7 being operated in conjunction with the motor 6. Since the gears 7 are speed reduction gears, the rotating force of the pickup drive motor 6 passes through the gears 7 with a reduced speed. The rotating force is, thereafter, applied to a rack gear 8, which is integrated with the pickup 5 into a single structure. At the rack gear 8, the rotating force of the motor 6 is converted into a linear moving force, thus reciprocating the pickup 5 along a guide rod 9 of the deck 2.

FIG. 2 is a sectional view showing the construction of a typical spindle motor device for disc players in detail. As shown in the drawing, the typical spindle motor device is comprised of a spindle motor 3, which is mounted to the deck 2. The spindle motor 3 has a slender spindle 3A at the top. Fixedly fitted over the top of the spindle 3A is a turntable 1, of which the top forms a disc guide 1A at the center. The disc guide 1A guides an optical disc D thus stably loading the disc D onto the turntable 1 while precisely centering the disc D and the turntable 1 together. In order to chuck the disc D onto the turntable 1 magnetically, a magnetic chucking means is positioned on the disc D after the disc D is loaded on the turntable 1. The chucking means is comprised of a chuck 10 with a magnet 11. The magnet 11 is held on the chuck 10 by a holding bracket 12, which is fixed to the chuck 10 by a screw 13 with the magnet 11 being interposed between the chuck 10 and the bracket 12.

However, the above spindle motor device is problematic in that the spindle 3A extends from the spindle motor 3 to the turntable 1 so that the spindle 3A is long and slender enough to cause vibrations of the optical disc D when the turntable 1 with the disc D is rotated by the rotating force of the spindle motor 3. Such vibrations of the disc D deteriorate picture quality of a disc player. The long spindle 3A also thickens the deck 2 thus causing a problem while designing the disc player.

Another problem experienced in the known spindle motor device is that it is difficult to precisely fit the turntable 1 over the top of the slender spindle 3A, reducing work efficiency while assembling the spindle motor 3 with the turntable 1 into a single body. The turntable 1, separately produced separately from the spindle motor 3 and assembled with the motor 3, also increases production cost of the disc player.

### SUMMARY OF THE INVENTION

An object of the present invention is to provide a spindle motor device for disc players, which has an integrated rotor in place of a typical separated turntable, allowing the deck of a disc player to be free from such a separate turntable and reducing production cost of the disc player, and improving work efficiency while assembling the set.

Another object of the present invention is to provide a spindle motor device for disc players, which has a rotating shaft rotatably supported by two bearings with an elongated bearing span suitable for preventing vibrations of the disc and improving picture quality of a disc player.

A further object of the present invention is to provide a spindle motor device for disc players, which reduces the thickness of the deck thereby allowing the deck to be easily designed while meeting the recent trend of thinness and lightness of the deck.

In order to accomplish the above objects, the present invention provides a spindle motor device for disc players, comprising: a bracket mounted to a deck and having a fixed coil; a rotating shaft rotatably held on said bracket by bearing means; and a rotor with turntable function rotating an optical disk chucked by a chucking device by magnetic field formed when electric power is supplied to said coil of the bracket.

Preferably, said rotor supported on the top of a portion protrudes from a bearing housing which is fixed to the bracket with bearings rotationally supporting said rotating shaft.

Also, it is preferable that said rotor is integrated with disc guide which is integrated with the top of said rotating shaft and which chucks said optical disc by means of said chucking device.

### BRIEF DESCRIPTION OF THE ACCOMPANYING DRAWINGS

The above and other objects, features and other advantages of the present invention will be more clearly understood from the following detailed description taken in conjunction with the accompanying drawings, in which:

FIG. 1 shows a deck for disc players with both a spindle motor device and an optical pick up;

FIG. 2 is a sectional view showing the construction of a typical spindle motor device for disc players chuck of which generates rotating force; and

FIG. 3 is a sectional view showing the construction of a spindle motor device for disc players in accordance with the preferred embodiment of the present invention.

### DESCRIPTION OF THE PREFERRED EMBODIMENTS

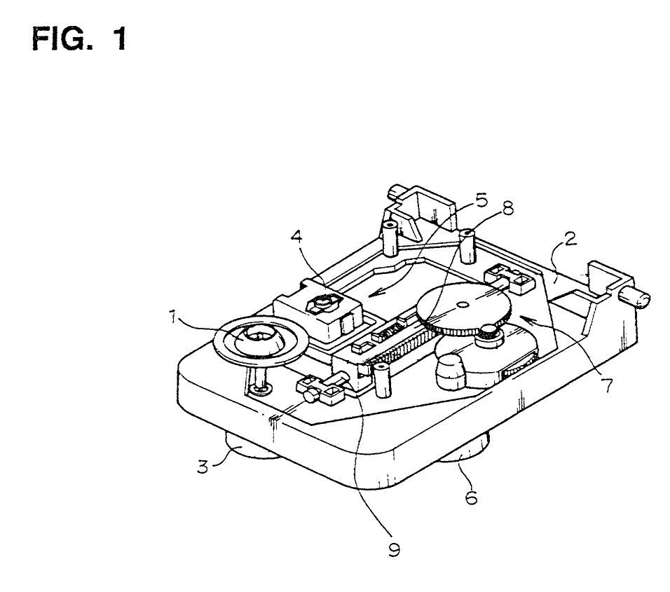

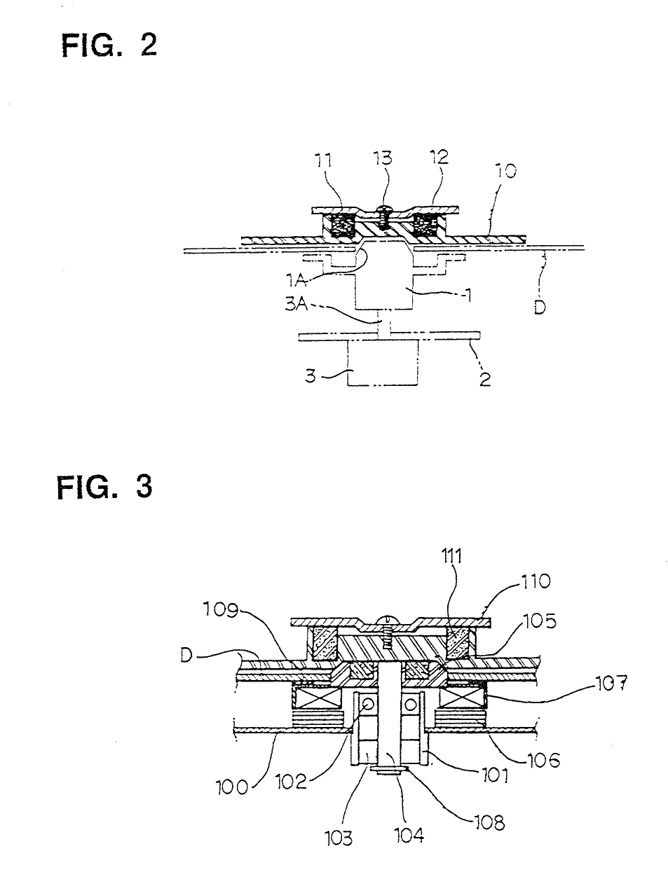

The spindle motor device of this invention is used with a deck, of which the general shape remains the same as in the embodiment of FIG. 1, but the spindle motor device is altered to accomplish the above-described objects of this invention. Those elements common to both the deck of FIG. 1 and the deck used with the spindle motor device of this invention will thus carry the same reference numerals and further explanation is thus not deemed necessary.

In the spindle motor device of this invention, a bracket 100 with a fixed bearing housing 101 is mounted to a deck as shown in FIG. 3. The spindle motor device also has a rotating shaft 104, which is rotatably and stably supported by two bearings 102 and 103 in the bearing housing 101. The two bearings 102 and 103 are fitted in the housing 101 at upper and lower positions, respectively, with a lengthened bearing span suitable for stably holding the shaft 104. Integrated with the top of the rotating shaft 104 is a disc guide 105, which guides an optical disc D when the disc D is loaded onto an operational position. A rotor 107 is integrated with the disc guide 105 so that the rotating shaft 104, the guide 105 and the rotor 107 are integrated together into a single structure. The rotor 107 is started to rotate at the time electric power is applied to a coil 106 of the bracket 100. The coil 106 acts as a stator of the spindle motor device.

In FIG. 3, the reference numeral 108 denotes an E-ring for preventing unexpected separation of the bearing housing 101 with the bearings from the rotating shaft 104, the numeral 109 denotes a rubber which is attached to the top surface of the rotor 107 and prevents the disc D from unexpectedly slipping on the rotor 107, and the numeral 110 denotes a magnetic chuck which magnetically chucks the disc D onto the rotor 107 by a magnet 111.

In the operation of the deck with the spindle motor device of this invention, a selected disc D on a disc tray (not shown) is moved to the operational position on the deck by a tray drive means (not shown). When the tray is stopped at the operational position, the disc D is loaded onto the rotor 107 under the guide of the disc guide 105. Thereafter, the chuck 110 with the magnet 111 is positioned onto the disc guide 105 so that the disc D is magnetically chucked on the rotor 107.

When the stator or the coil 106 of the bracket 100 is turned on, a relative electric action is formed between the coil 106 and the rotor 107 thus rotating the rotor 107 at a predetermined speed. The rotating shaft 104 is stably held by the two bearings 102 and 103 at its upper and lower portions as described above so that the rotor 107, integrated with the top of the rotating shaft 104 through the disc guide 105, is almost free from vibrations. The disc D on the rotor 107 is thus almost prevented from vibrations.

Since the rotor 107 with the disc D is stably rotated without being vibrated as described above, the optical pickup with an object lens can precisely radiate a laser beam onto the disc D through the object lens while radially moving on the disc D. The disc player with the spindle motor device of this invention thus precisely records or plays back data onto or from the disc D.

As described above, the present invention provides an improved spindle motor device used for holding and rotating a disc in a disc player. The spindle motor device has an integrated rotor in place of a typical separate turntable so that the device improves work efficiency while assembling a deck of the disc player and reduces production cost of the disc player.

In addition, the rotating shaft of the spindle motor device is stably supported by a bearing while reducing the length of the exposed part of the shaft so that the shaft almost completely prevents the disc on the rotor from vibrations and improves picture quality of the disc player. The above rotating shaft also reduces the thickness of the deck, thereby allowing the deck to be easily designed while meeting the recent trend of thinness and lightness of the deck.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A spindle motor device for disc players, comprising:
a bracket mounted to a deck and having a fixed coil;
a rotating shaft rotatably held on said bracket by bearing means; and
a rotor with turntable function whereby an optical disk chucked by a chucking device is rotated by magnetic field formed when electric power is supplied to said coil of the bracket.

2. The spindle motor device of claim 1, wherein said rotor supported on the top of a portion protruding from a bearing housing, said bearing housing being fixed to the bracket with bearings rotationally supporting said rotating shaft.

3. The spindle motor device of claim 1, wherein said rotor is integrated with disc guide which is integrated with the top of said rotating shaft and which chucks said optical disc by means of said chucking device.
